(19) United States
(12) Patent Application Publication
(10) Pub. No.: US 2005/0102985 A1
(43) Pub. Date: May 19, 2005

(54) Knocked-down air filter for internal combustion engine

(76) Inventor: Heru Prasanta Wijaya, Surabaya (ID)

Correspondence Address: CHRISTIE, PARKER & HALE, LLP, PO BOX 7068, PASADENA, CA, 91109-7068, US

(21) Appl. No.: 10/506,394

(22) PCT Filed: Sep. 4, 2002
(86) PCT No.: PCT/IB02/03574

(30) Foreign Application Priority Data
Mar. 8, 2002 (ID) P00200200120

(51) Int. Cl. B01D 46/00

(52) U.S. Cl. 55/498

(57) ABSTRACT

Efficiency leading to saving in transportation is a must at this competitive era. The choice of an automotive vehicle as a transportation means in mining, plantation, and forestry entails a special tactics in order to minimize the operational, maintenance and replacement cost of the air filter used in its internal combustion engines, especially the air filter whose entire parts should be replaced when its clogged filtering medium (7) is replaced. The air filter presently invented is a knocked-down air filter, i.e., an air filter whose part that should be replaced is its filtering medium (7) and inner mesh (6) only which are bound together by lower rubber (5) and upper rubber (8). Its other parts such as lower housing (1), upper housing (9), perforated plate (3) and reinforcing pile (4) are not necessarily replaced. A manually opened and closed locker (11) unite this knocked-down air filter as a single unit.

### FIELD OF THE INVENTION

This invention relates to an air filter for an automotive engine.

### BACKGROUND OF THE INVENTION

Vehicles play an important role in economy especially as the means of transportation for goods and personnel. Of them, trucks and buses are of the most importance in connection with this invention. These vehicles adopt internal combustion engine for operation.

The choice of automotive vehicles as a transportation means entails a specified strategy in order to minimize the operational and maintenance cost.

Industries such as mining, plantation, and forestry are other examples of fields in which this invention is applied. The most frequently used vehicles in the those fields are dump trucks, excavators, forklifts and multiple-wheeled trucks.

There are still a lot of industrial machines and electrical generators that use internal combustion engine for their operation.

One of the internal combustion engine components that needs maintenance and periodic replacement is air filter. This air filter must be periodically be replaced in order to make the fresh air needed for the efficient combustion in the engine keep existing there.

The use of this knocked-down air filter in an internal combustion engine will save a lot of money because its part only that should be periodically replaced for an efficient combustion in the engine.

### BRIEF DESCRIPTIONS OF THE INVENTION

Object of this invention is an air filter which can be knocked-down for the reduction of maintenance and replacement cost in an internal combustion engine.

Air filter of current use (FIG. 1) generally comprises lower housing plate (1) portion, filtering medium (7), perforated plates (3), and inner mesh (6) assembled as a unit by lower rubber (5) and upper rubber (8) acting, too, as a binder. For this kind of air filter, all of its components should be replaced when we replace the air filter.

The preferred embodiment of this invention (FIG. 2) comprises a lower housing (1) as a base, perforated plate (3) hooked to a holding ring (2) at the lower part thereof and bound to an upper reinforcing ring (10) at the upper part thereof. The perforated plate (3) acts as a reinforcing means for the air filter construction and as a retaining means for filter housing (9) on the upper part of the air filter. To make the air filter more compact in construction, there is provided on its internal parts a reinforcing pile (4) whose upper part is bound to the upper reinforcing rings (10) and lower part is bound to the lower reinforcing ring (2).

Filtering medium (7) is generally folded longitudinally upward whilst inner mesh (6) is engaged with lower rubber (5) and upper rubber (8). The unification into a single unit of the filtering medium (7) and the inner mesh (6) with the lower rubber (5) and the upper rubber (8) form a cylinder which can be separated individually from this air filter (FIG. 3). It is the single unit formed by the filtering medium (7) and the inner mesh (6) that should only be replaced, not all parts of the air filter.

For arrangement purpose, lower housing (1), perforated plate (3), reinforcing pile (4), upper reinforcing ring portion which can be opened for the insertion of the filtering medium (7), and upper housing plate, are unified with manually opened and closed locker (11). To avoid leakage, a seal (12) can be provided on this air filter engine when the air filter is attached on the combustion engine. Because the part that should be replaced is merely the filtering medium (7) which has been integrally bound with the inner mesh (6) by the lower rubber (5) and the upper rubber (8), the use of this invention will save a lot of money.

### BRIEF DESCRIPTION OF THE DRAWING

FIG. 1 is a traversed cross-section of the half of the air filter currently used.

FIG. 2 is a traversed cross-section of the half of the preferred embodiment of the air filter presently invented.

FIG. 3 is a traversed cross-section of the half of the filter medium.

FIG. 4 is a traversed cross-section of the half of the presently-invented knocked-down air filter in detached condition.

FIG. 5 is the traversed cross-section of the half of varied locking model.

FIG. 6 is a traversed cross-section of the half of the presently-invented knocked-down air filter with varied locking model using hook system.

### DETAILED DESCRIPTION OF THE INVENTION

The subject of this invention is an air filter which can be knocked-down in order to reduce maintenance and replacement costs in an internal combustion engine.

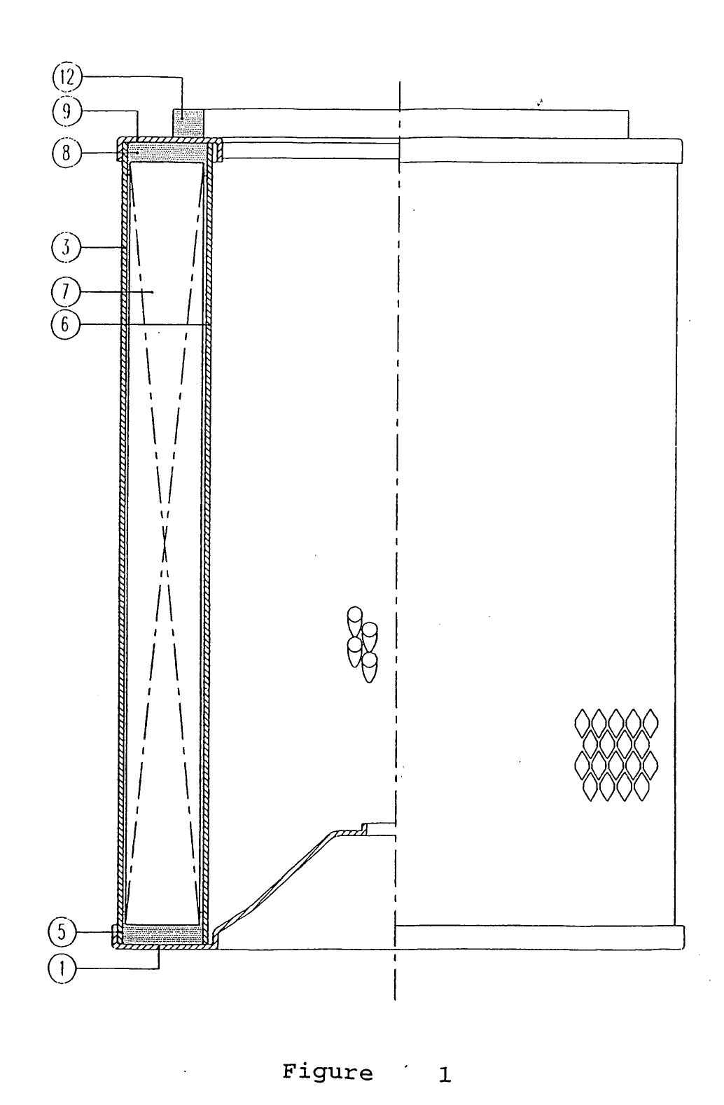

Air filter of current use (FIG. 1) generally comprises lower housing plate (1) portion, filtering medium (7) which can be upwardly folded, perforated plates (3), and inner mesh (6) formed as a cylinder and bound into an individual unit by the lower rubber (5) and upper rubber (8) which acts too as a binder. With such a configuration, it is merely the filtering medium itself that should be replaced, not the whole parts of the air filter.

Part of an air filter that should be replaced is actually the filtering medium only. This medium, when clogged, causes the fresh air unable to enter the combustion chamber of an internal combustion engine.

Based on this consideration, it is developed an economic knocked-down air filter where only its filtering medium (7) and inner mesh (6) that should be periodically replaced. Inner mesh (6) provided as a means of maintaining The shape of the filtering medium is maintained by inner mesh (6) which is defined by upwardly extending longitudinal folds.

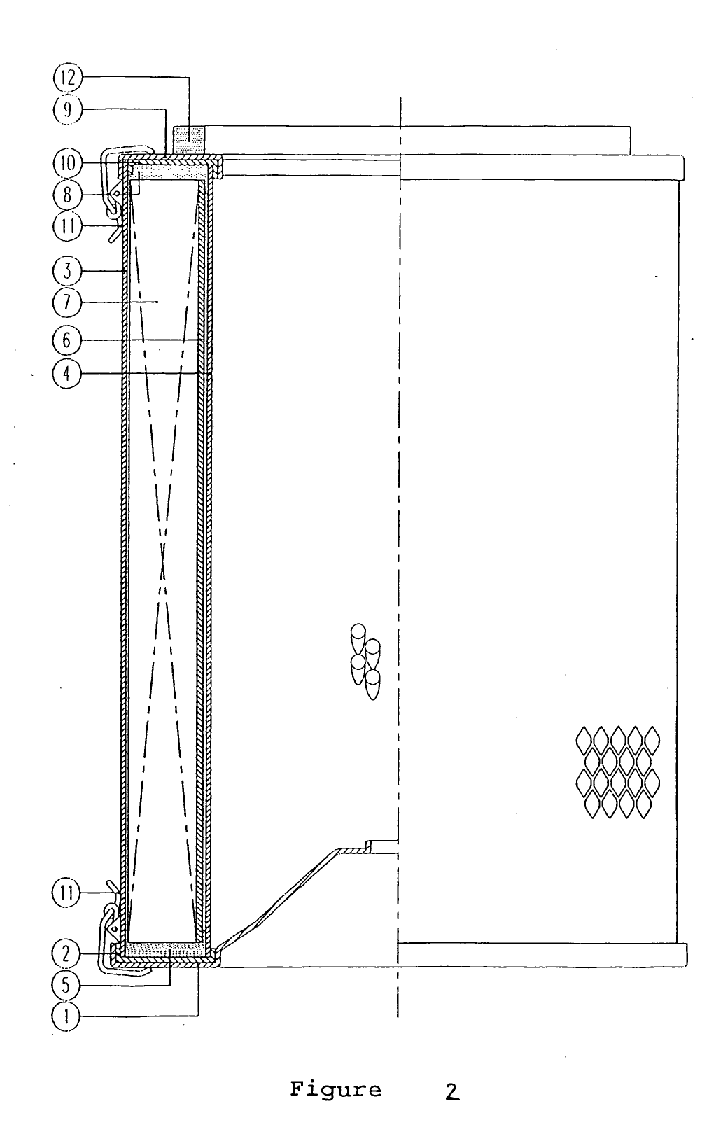

The preferred embodiment of this invention (FIG. 2) comprises a lower housing (1) as a base, perforated plate (3) hooked to a holding ring (2) at its lower part and bound to an upper reinforcing ring (10) at its upper part. Perforated plate (3) function as a reinforcing means for the air filter construction and as a retaining means for filter housing (9) on the upper part of the air filter. To make the air filter more compact in construction, there is provided on its internal parts a reinforcing pile (4) whose upper part is bound to the upper reinforcing rings (10) and lower part is bound to the lower reinforcing ring (2).

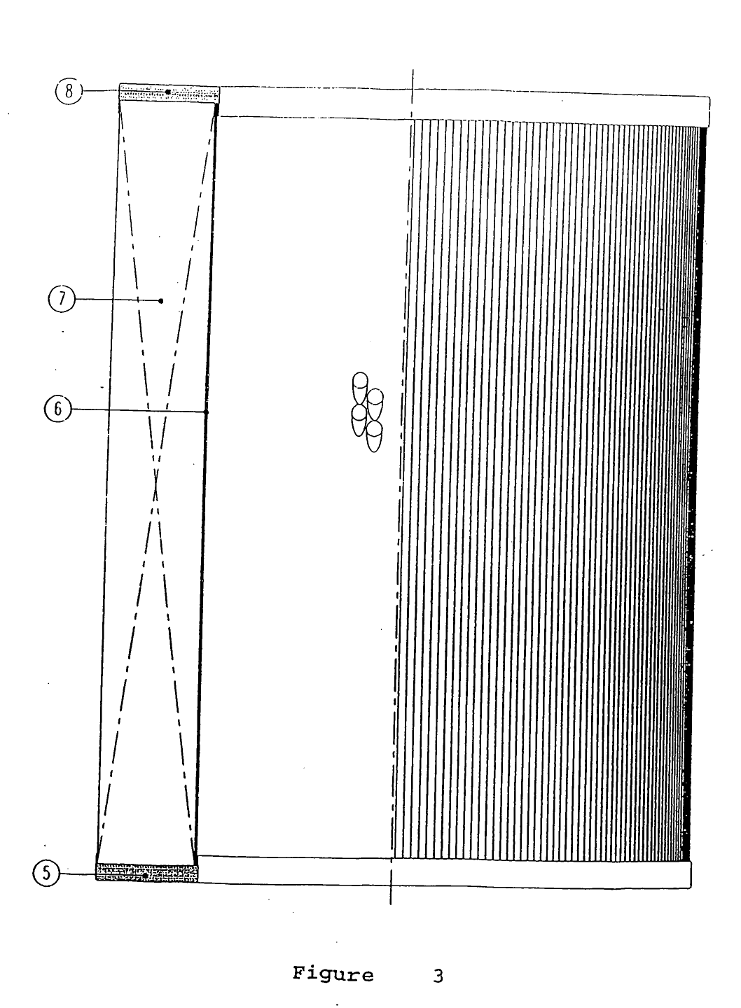

Filtering medium (7) is generally folded longitudinally upward whilst inner mesh (6) is engaged with lower rubber (5) and upper rubber (8). The unification into a single unit of the filtering medium (7) and the inner mesh (6) with the lower rubber (5) and the upper rubber (8) form a cylinder which can be separated individually from this air filter (FIG. 3). It is the single unit formed by the filtering medium (7) and the inner mesh (6) that should only be replaced, not all parts of the air filter.

In arranging the air filter, lower housing (1), perforated plate (3), reinforcing pile (4), upper reinforcing ring portion which can be opened for the insertion of the filtering medium (7), and upper housing plate, are unified with manually opened and closed locker (11). To avoid leakage, a seal (12) is provided on this air filter engine when the air filter is attached on the combustion engine.

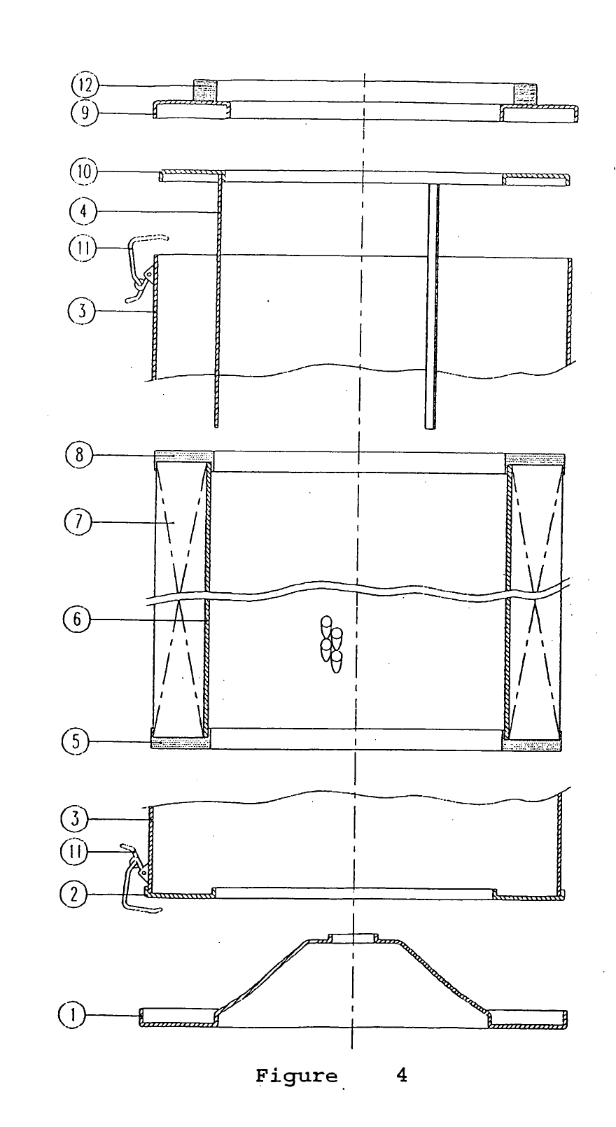

Because the part that should be replaced is merely the filtering medium (7) which has been integrally bound with the inner mesh (6) by the lower rubber (5) and the upper rubber (8), the use of this invention will save a lot of money. Parts of the presently invented air filter, i.e., air filter that can be knocked down, can be seen in FIG. 4.

For people skilled in the art, various modifications of the preferred embodiment are allowed as long as they do not depart from the spirit of the invention.

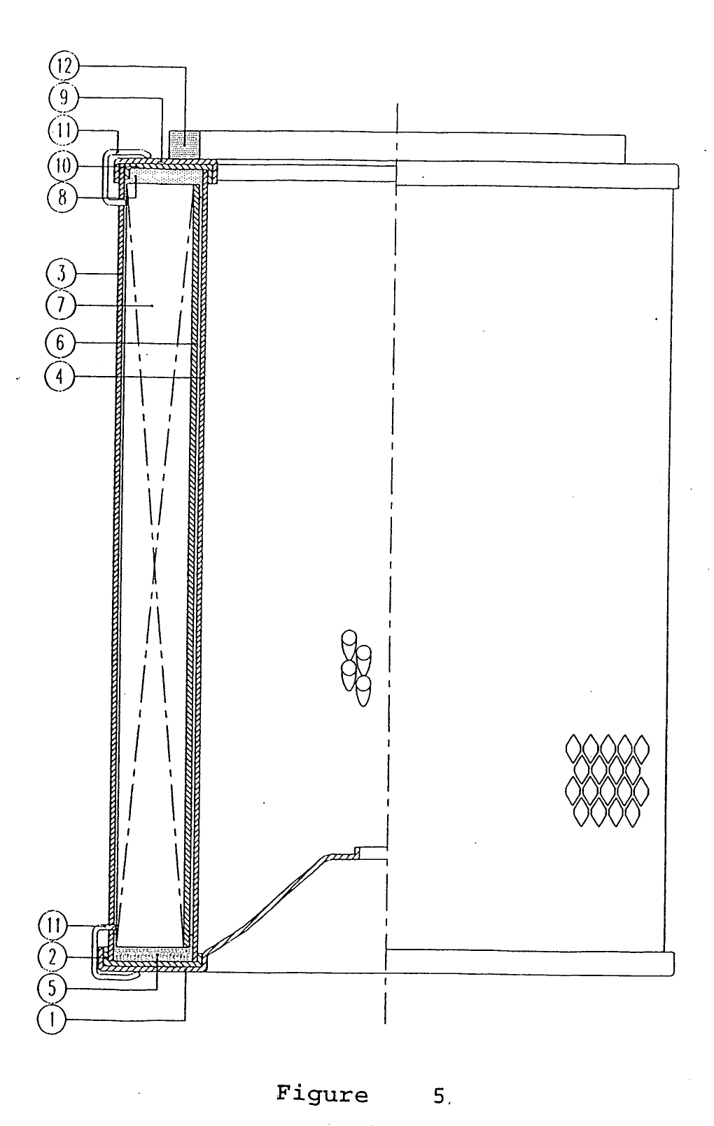

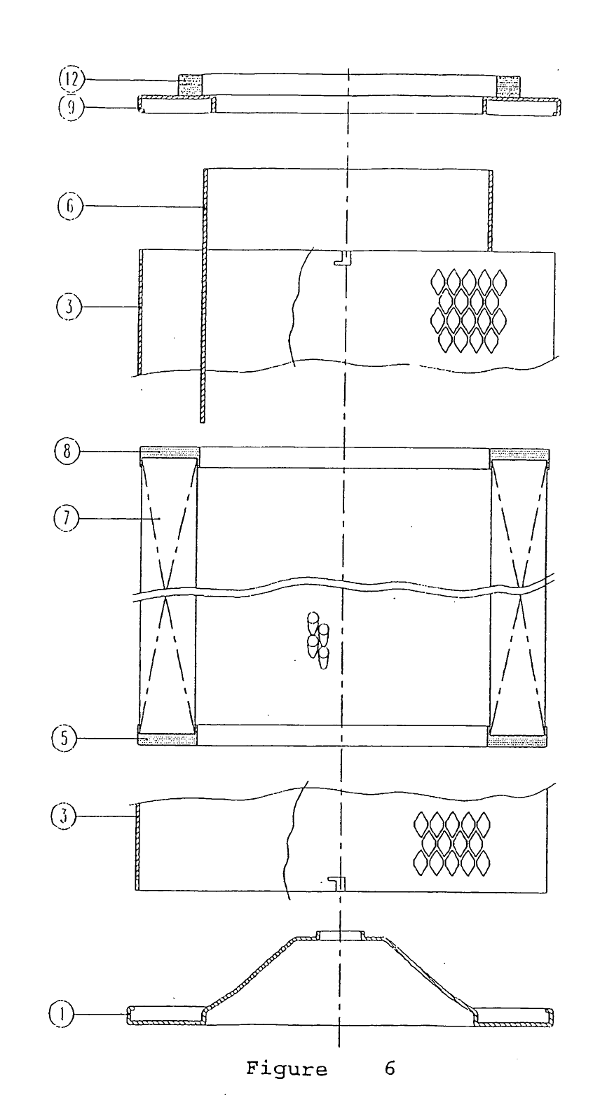

One of these modifications is the shape of the locker (11). This locker (11) should be bound on perforated plate (3), on lower housing (1), or on upper housing (9). It can also be clamped on one parts of the air filter instead of being bound on it (FIG. 5). Another characteristic that can be modified is the arrangement of the partial binding of the knocked down parts of the air filter. FIG. 6 shows a modified locking model of the lower housing (1) and the upper housing (9). The hook used for this modification can be a thread of a screw.

The shape of the reinforcing pile is also subject to modification, in which it can be as a spiral. Perforated plate can be replaced by reinforcing spiral or pile. Inner mesh (6) can be provided or not on the filtering medium. When provided, it can be separately made or replaced by spiral or pile. Longitudinal folds that form a filtering medium can also be made from polymeric material. A filtering medium medium without folds is also possible.

1. Knocked-down air filter for internal combustion engine characterized by
parts of a filtering medium (7) and inner mesh (6) engaged by lower rubber (5) and upper rubber (8) acting as a binder so that filtering medium (7) and inner mesh (6) engaged integrally;
detachable lower housing (1), perforated plate (3), reinforcing pile (4) and upper housing (9) which can be assembled, where parts of a filtering medium (7) and inner mesh (6) which have been engaged can be integrally formed into an air filter when combined with lower housing (1), perforated plate (3), reinforcing pile (4), and upper housing (9) by means of locker (11).

2. Knocked-down air filter for internal combustion engine defined in claim 1 in which the binding between lower housing (1) and upper housing (9) is effected by a perforated plate (3) by means of a hook-locking system.

3. Knocked-down air filter for internal combustion engine defined in claim 1 applying a clip-locking system.

4. Knocked-down air filter for internal combustion engine defined in claim 1 in which the binding between lower housing (1) and upper housing (9) is effected by a perforated plate (3) by means of a thread-locking system.

5. Knocked-down air filter for internal combustion engine defined in claim 1 with a reinforcing means in the form of a spiral.

6. Knocked-down air filter for internal combustion engine characterized by
parts of a filtering medium (7) and inner mesh (6) equipped with lower rubber (5) and upper rubber (8) which functions as a binder as well as stabilizer for the filtering medium (7) and its consistent shape;
detachable lower housing (1), perforated plate (3), inner mesh (6) and upper housing (9):
where parts of a filtering medium (7), lower housing (1), perforated plate (3), inner mesh (6) and upper housing (9) can be assembled into an air filter by means of locker (11).

7. Filtering medium (7) constituted by a plurality of upwardly extending folds made from filtering paper or other substances where rubbers are attached on upper and lower parts thereof in order to stabilize the shape of the filtering medium.

8. Knocked-down air filter for internal combustion engine disclosed in claim 6 in which the engagement model between lower housing (1) and upper housing (9) is effected by a perforated plate (3) and an inner mesh (6) using hook, clip and thread-locking systems.

9. Knocked-down air filter for internal combustion engine defined in claim 1 or claim 6 whose lower housing (1) and upper housing (9) are engaged by a reinforcing means in the form of spiral or pile.

10. Knocked-down air filter for internal combustion engine defined in claim 6 where the folded body of the filtering medium is provided with a plastic reinforcing substance wound as a ring around the filtering medium.
